(19) United States
(12) Patent Application Publication
(10) Pub. No.: US 2010/0114446 A1
(43) Pub. Date: May 6, 2010

(54) Motor Vehicle Electric System

(76) Inventors: Wolfgang Fey, Niedernhausen (DE); Günther Fendt, Schrobenhausen (DE); Manfred Kulesch, Ingolstadt (DE)

Correspondence Address: RATNERPRESTIA, P.O. BOX 980, VALLEY FORGE, PA, 19482, US

(21) Appl. No.: 12/524,054

(22) PCT Filed: Jan. 17, 2008
(86) PCT No.: PCT/EP08/50529

§ 371 Date: Dec. 3, 2009

(30) Foreign Application Priority Data
Jan. 25, 2007 (DE) 102007003711.4
Nov. 22, 2007 (DE) 102007056363.0

(51) Int. Cl. B60T 8/176; G06F 19/00

(52) U.S. Cl. 701/71; 701/1

(57) ABSTRACT

A motor vehicle control system having a coil switch which is connected to the vehicle electric system is intended to permit reliable operation of a coil switch without power losses in the semiconductor switches. For this purpose, a step-up converter is connected between the vehicle electric system and the coil switch.

### CROSS REFERENCE TO RELATED APPLICATIONS

This application is the U.S. national phase application of PCT International Application No. PCT/EP2008/050529, filed Jan. 17, 2008, which claims priority to German Patent Application No. DE102007003711.4, filed Jan. 25, 2007 and German Patent Application No. DE102007056363.0, filed Nov. 22, 2007, the contents of such applications being incorporated by reference herein.

### BACKGROUND OF THE INVENTION

1. Field of the Invention

The invention relates to a motor vehicle control system having a coil switch which is connected to the vehicle electric system.

2. Description of the Related Art

The design of existing motor vehicle control systems is usually tailored to required safety aspects. This usually refers, inter alia, to the functionality of the components connected to the motor vehicle electric system in the case of autonomy, i.e. when the power supply is interrupted. Such aspects may be significant, in particular, for the supply of power to safety-related components such as, for example, airbag systems.

The document DE 197 46 546 C1 discloses, for example, a power supply unit for a motor vehicle electric system which is suitable for performing an autonomy functionality, such as is required in the case of airbag systems. So that in the case of autonomy the system functionality can be maintained here for a certain, required minimum time, in the normal operating state in this known system an autonomy capacitor is charged to a voltage which is raised compared to the voltage of the vehicle electric system, wherein in the case of autonomy the energy of the capacitor is then made available to the input of the system by means of a switch device.

On the other hand, the motor vehicle circuit arrangement is implemented differently in brake systems, for example in ABS systems, since an autonomy functionality is usually not required in a brake system. Owing to the differing requirements, in the prior art the brake systems are supplied directly with energy by the vehicle supply/battery voltage, with the possible fluctuations in the voltage of the vehicle electric system or the supply voltage (6 V to 16 V) making it necessary to adapt the system electronics correspondingly to these given fluctuations of the vehicle electric system in order to ensure reliable functioning. This means in practice that only the lowest supply voltage of approximately 6 V (undervoltage) can be used as a basis for the system configuration.

It has to be considered a disadvantage of an application such as the one mentioned last that, in order to control the valves of the ABS system by means of a coil switch, it is necessary to make available relatively high coil currents which are switched by semiconductor switches so that the energy required to control the solenoid valves can be made available at the exciter coils. However, using high currents in the control mode gives rise to large power losses in the semiconductor components. Such a power lower in the active control mode has an adverse effect on the safety and reliability of such brake systems.

### SUMMARY OF THE INVENTION

In one aspect, the invention provides a motor vehicle control system which permits reliable operation of such a coil switch with a power loss in the semiconductor switches which is kept particularly low.

This object is achieved according to aspects of the invention in that a step-up converter is connected between the vehicle electric system and the coil switch.

In one aspect, the invention is based here on the idea that the power losses in the semiconductor switches should be reduced for the sake of reliable and safe operation of the coil switch. Such a reduction in the power loss in the semiconductor switches is possible by reducing the current flowing through them. In order to make available the energy which is required to control the solenoid valves while using low coil currents, it is therefore necessary for a raised voltage to be applied here. Since, on the one hand, established power supply units have to be used in the vehicle electric system supply for reasons of system compatibility and, on the other hand, such a raised voltage cannot be obtained directly from the voltage of the vehicle electric system because of possible fluctuations, a step-up converter for raising the voltage of the vehicle electric system is therefore connected upstream of the coil switch.

In order to supply an ABS system with such a raised voltage, the coil switch is advantageously configured as an ABS coil switch. So that the coil switch or the ABS brake system can also be used in the case of autonomy, a buffer accumulator is particularly advantageously connected between the step-up converter and the coil switch. Such a buffer accumulator increases the operational safety of the ABS system here since even if the power supply is interrupted the ABS system can still be used for a certain time, and the motor vehicle can therefore continue to be safely steered or braked. In addition, it is possible here to connect safety systems which require an autonomy functionality, for example the airbag system, via the same supply line as the ABS system. The buffer accumulator therefore not only ensures the autonomy of the ABS brake system but also that of other safety components such as, for example, of the airbag system.

In order to use further end users with a relatively low input voltage, a step-down converter is advantageously connected downstream of the step-up converter. In this context, it depends on the autonomy functionality of the connected components whether the step-down converter is connect upstream or downstream of the buffer accumulator. Both possibilities are conceivable depending on the purpose of use. In this context, for example, further linear controllers could be connected to the step-down converter in order to generate a stabilized working voltage or sensors for measuring the working voltage may be connected. In this context, it is also possible for the output voltages of the step-down converter to have a different voltage potential depending on the purpose of use.

In one particularly advantageous embodiment, such a motor vehicle control system is used with control coils and coil switches provided for that purpose in an ABS system of a motor vehicle.

The advantages achieved with the invention are, in particular, the fact that the connection of a step-up converter between the vehicle electric system and the coil switch brings about a reduction in the coil current while the energy which is made available for controlling the solenoid valves stays the same. Furthermore, the inductivity of the coil and the power loss in the semiconductor switches are reduced, permitting increased safety and reliability during the operation of the coil switch. Furthermore, owing to the reduced currents the solenoid valve coils can be given smaller dimensions and therefore made more compact. As a result of the use of a buffer accumulator for making available the voltage even in the case of autonomy, i.e. when the power supply is interrupted, the coil current is made independent of the supply voltage of the vehicle electric system and of its fluctuations. Furthermore, a high level of protection against interference pulses due to the supply voltage of the vehicle electric system is provided.

### BRIEF DESCRIPTION OF THE DRAWINGS

The invention is best understood from the following detailed description when read in connection with the accompanying drawing. Included in the drawing are the following figures:

FIG. 1 is a schematic diagram of a control system in accordance with an exemplary embodiment of the invention.

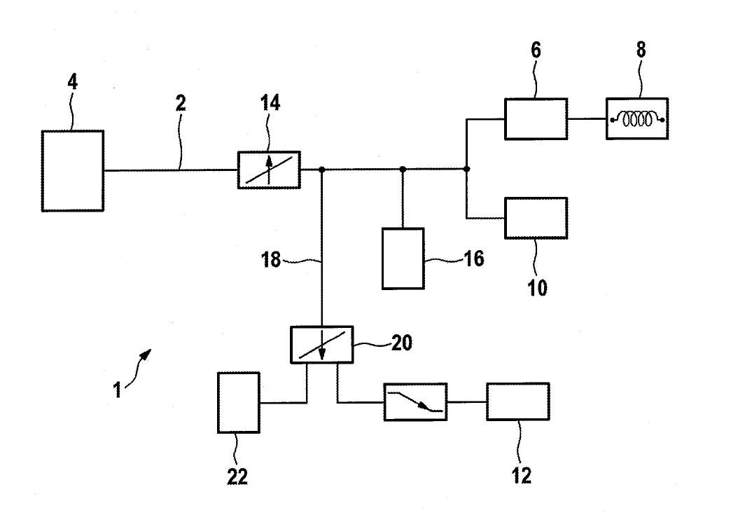

### DETAILED DESCRIPTION OF THE PREFERRED EMBODIMENTS

The control system 1 of a motor vehicle according to the FIGURE comprises, for the purpose of supplying a number of loads such as, for example, switches, sensors or the like, a bus bar 2, which is connected on the input side to the vehicle electric system 4, for example to the motor vehicle battery, and at the same time, in particular, by its positive pole to a correspondingly applied supply voltage (also referred to as terminal 15/30). Loads which are to be supplied here and which are connected to the bus bar 2 are a coil switch 6 of a downstream ABS system, by way of example for which a control coil 8 is illustrated, an airbag system 10 and a number of further regulators 12 (not specified in more detail). In order to activate the ABS system, the coil current for the downstream coil 8 is connected via the coil switch 6, which is embodied as a semiconductor switch in the exemplary embodiment, with the result that the control units or solenoid valves which are connected downstream of said coil 8 become active.

The motor vehicle control system 1 is configured for a particularly high level of operational reliability in terms of the actuation of the coil switch 6, in which context a power loss which is kept particularly low is to be ensured in the respective semiconductor switch. Furthermore, in terms of the configuration of the motor vehicle control system 1, particularly low sensitivity of the coil current to fluctuations in the supply voltage of the vehicle electric system or to interference pulses from the supply voltage of the vehicle electric system is aimed at. In order to achieve this, the motor vehicle control system 1 is provided for applying a coil current which is kept particularly low to the coil switch 6, which, furthermore, also permits the design of the individual components to be kept particularly compact. So that it is nevertheless possible to use this configuration to reliably make available the switching energy necessary to actuate the solenoid valves, in addition to the configuration for coil currents which are kept comparatively low the coil switch 6 is equipped to permit the application of an input voltage which is stepped up compared to the supply voltage. Accordingly, in the motor vehicle control system 1 the coil switch is connected to the bus bar 2, and therefore to the vehicle electric system 4, via the intermediate connection of a step-up converter 14.

It is conceivable in this context that in addition to the step-up converter 14 located in series between the vehicle electric system 4 and the coil switch 6 there are further components in parallel or in series with the step-up converter 14. Such a component may be, for example, a diode which, for reasons of protection against polarity reversal, can be additionally connected in series between the vehicle electric system 4 and the coil switch 6.

The step-up converter 14 converts the voltage supply made available here by the vehicle electric system via the bus bar 2 to a relatively high voltage which is applied to the coil switch 6 for the abovementioned reasons. In order in this context to ensure even further increased operational safety even for the case of a temporary failure of the voltage supply, what is referred to as the case of autonomy, an energy store or buffer accumulator 16, in which the supply voltage which is raised in the step-up converter 14 can be buffered, is additionally connected between the step-up converter 14 and the coil switch 6. As a result of the intermediate connection of the buffer accumulator 16, it is therefore also possible to apply a supply voltage which has been stepped up by means of the step-up converter 14 to particularly safety-related systems and systems which are subject to autonomy criteria such as, for example, the airbag system 10. As a result, the system functionalities such as the airbag system 10 and the ABS system which is connected downstream of the coil switch 6 in the motor vehicle control system 1 are supplied with energy by the supply voltage which is converted to a higher level by means of the step-up converter 14, while in the normal operating case the energy requirement of these systems is adjusted directly by means of the step-up converter 14. Therefore, in the normal operating case a virtually constant supply voltage is maintained at the buffer accumulator 16. In the case of autonomy, that is to say when the supply voltage is interrupted, the airbag system 10 can still be supplied with energy via the buffer accumulator 16 given such a configuration, with the result that the functionality of said airbag system 10 is ensured for a certain required minimum time after the failure of the supply voltage. As a result of this configuration, that is to say in particular as a result of the additional intermediate connection of the buffer accumulator 16, a combined voltage supply for the aforesaid motor vehicle safety systems with a comparatively stepped-up supply voltage is therefore provided.

A number of further loads 12 are connected to the bus bar 2 via a branch line 18, in which case the branch line 18 branches off in the supply line downstream of the step-up converter 14. In order, in this context, to permit further loads to be supplied in the manner of a conventional voltage supply, a step-down converter 20, downstream of which the further loads are connected, is connected to the branch line 18 which is also buffered moreover by the buffer accumulator 16. It is possible, for example, to connect linear controllers for generating a stabilized working voltage, for example for the logic or the microprocessor of the motor vehicle electronic system, to the output of the step-down converter 20. Furthermore, a sensor 22 for monitoring the output voltage is connected to the output side of the step-down converter 20.

1-8. (canceled)

9. A motor vehicle control system comprising a coil switch connected to a vehicle electric system, wherein a step-up converter is connected between the vehicle electric system and the coil switch.

10. The motor vehicle control system as claimed in claim 9, wherein the coil switch is an ABS coil switch.

11. The motor vehicle control system as claimed in claim 9, wherein a buffer accumulator is connected between the step-up converter and the coil switch.

12. The motor vehicle control system as claimed in claim 9, wherein a step-down converter is connected downstream of the step-up converter.

13. A control coil for an ABS system having an assigned coil switch, wherein the control coil is configured for operation in a motor vehicle control system as claimed in claim 9.

14. The control coil as claimed in claim 13 wherein the control coil is a solenoid valve coil.

15. A coil switch for a control coil as claimed in claim 13, wherein the coil switch is configured for operation with coil currents which are kept low when there is an input voltage which is stepped up compared to the supply voltage of the vehicle electric system.

16. An ABS system for a motor vehicle having a motor vehicle control system as claimed in claim 9.

17. A motor vehicle having an ABS system as claimed in claim 16.

18. An ABS system for a motor vehicle having a number of control coils as claimed in claim 13.

19. A motor vehicle having an ABS system as claimed in claim 18.

20. An ABS system for a motor vehicle having a number of coil switches as claimed in claim 15.

21. A motor vehicle having an ABS system as claimed in claim 20.
